(19) United States
(12) Patent Application Publication
(10) Pub. No.: US 2009/0168680 A1
(43) Pub. Date: Jul. 2, 2009

(54) MULTIPLE MULTICAST DATA STREAM DELIVERY IN A COMMUNICATION NETWORK

(75) Inventors: Ajoy K. Singh, Round Lake, IL (US); Ivan N. Vukovic, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/965,182

(22) Filed: Dec. 27, 2007

(51) Int. Cl. H04H 20/71

(52) U.S. Cl. 370/312

(57) ABSTRACT

Multiple multicast data stream delivery in a communication network includes a first step (700) of providing a proxy agent for a mobile node. A next step (702) includes determining a multicast group the mobile node intends to join. A next step (704) includes receiving feedback about radio link characteristics of the mobile node by the proxy agent. A next step (706) includes using the radio link characteristics by the proxy agent on behalf of the mobile node to join or remove the mobile node from the group.

### FIELD OF THE INVENTION

The present invention relates generally to wireless communication networks, and in particular, a network and method for multiple multimedia data stream delivery.

### BACKGROUND OF THE INVENTION

Multimedia and group communications are becoming more important aspects of telecommunication networks, and the demand for such services will continue to increase. For instance, there are presently many different systems and networks driving 3GPP/3GPP2/IEEE to provide group communication and efficient multicast support in a growing popularity of multimedia applications in next generation wireless access network such as LTE, UMB, HSDPA, DO-A, and 802.16x, etc. Public safety organizations are particularly interested in group communications and dedicated resources are being provided for these organizations. However, businesses and even personal users also have a desire to use multimedia and group communication.

Accordingly, a suite of protocols has been developed for use in group communications. These protocols are used to control broadcast and multicast communications sessions including data streams such as audio (voice), video, text messaging, and internet protocols, for example between, or to, users (also referred to herein as subscribers or mobile nodes) in a communications network.

A multicast group communication has the efficiency of delivering multiple informational streams to a mobile node depending upon that mobile node's multicast radio link characteristics and capabilities. To enable efficient support for multicasting, several radio link optimizations have been identified and are being considered for implementation. For example, to meet the need of mobile nodes with different radio link characteristics, hierarchical coding of video streams is being considered. Hierarchical coding would require a video source to send multiple (layered) video streams to the mobile nodes. However, the quality of video content would depend upon the number of streams the mobile node is able to receive and combine to re-produce the final video output. Similarly, video and audio could be delivered to mobiles using separate streams.

Delivery of multiple streams of video content to the mobile would enable radio link optimization, but would also require infrastructure routers such as access and core routers to support multicast routing for multiple streams. Also, there is a need to have an efficient signaling mechanism to effectively manage the membership to various multicast groups, otherwise all the streams of a video contents will be delivered to a serving base station even if a mobile node being served is not able to receive the contents associated with a given video stream. The problem becomes how to assign mobiles to the appropriate multicast groups.

One approach would be to put the responsibility on the mobile itself, and make it responsible for deciding when it should join and leave the appropriate multicast groups (i.e. mobile-initiated multicast group management). For example, a mobile at the fringe of a cell should only be joined with a “basic” multicast group. However, this approach introduces problems including: adding messaging over-the-air to join/leave multicast groups, and the possibility that “leave” messages sent by a mobile at the edge of a cell may be lost or delayed. As a result, this solution would not provide optimal performance due to possible loss of signaling packets, high round trip delay, etc. Moreover, it is highly likely that mobile-initiated signaling messages will be dropped when the mobile is on the edge of a cell. Further, the inability to drop mobile nodes from a multicast group in timely manner would cause un-necessary delivery of multicast streams to the serving base station even when the base station does not have any mobile user with the capability to receive the multicast flow thereby wasting backhaul bandwidth. Also, supporting mobile-controlled multicast group management will have unnecessary over-the-air Internet Group Management Protocol (IGMP) control messages thereby wasting radio resources.

Therefore, a need exists for a network and method for management of multiple multicast data stream delivery in a communication network.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 illustrates an example of hierarchical coding of a video stream that can be used in accordance with the present invention;

FIG. 2 illustrates an example of temporal scalable video encoding that can be used in accordance with the present invention;

FIG. 3 illustrates an example of spatial scalable video encoding that can be used in accordance with the present invention;

FIG. 4 illustrates an example of a layered video transport that can be used in accordance with the present invention;

FIG. 5 illustrates a simplified block diagram of a network, in accordance with the present invention;

FIG. 6 illustrates a simplified flow diagram, in accordance with the present invention; and

FIG. 7 illustrates a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF THE PREFERRED EMBODIMENT

The present invention provides a network and method for management of multiple multicast data stream delivery in a wireless access communication network. The wireless access network is designed to support the delivery of a multicast stream to a mobile node through a serving base station. Due to the inherent characteristics of a radio link, it is most likely that a mobile node near its serving base station will be able to receive content at much higher data rate compared to the scenario where the mobile node is located at the edge of the cell. In addition, to address changing radio condition, multimedia content will be encoded using hierarchical encoding. So, basically a given multimedia stream will be split into multiple multimedia streams and delivered to the mobile node over the radio link. Preferably, all this is accomplished in a secure manner supporting confidentiality, authentication, and integrity of the multimedia data stream.

Also, unlike a wired network, the network controlled multicast group management of the present invention will take into account the radio link conditions (e.g. Channel Quality Indicator (CQI) feedback) of mobile nodes to decide about when to drop a multicast group associated with mobile node. Since CQI feedback is an early indication of mobile node radio link conditions, it is possible to make optimal decision about multicast group management.

Mobile nodes will try to receive as many multimedia streams as possible and combine them to produce a higher resolution multimedia content. So basically splitting a media streams into multiple streams will also mean that the access networks and core networks will have to simultaneous manage several multicast sessions. Accordingly, the present invention provides an efficient signaling mechanism to effectively manage the membership to various multicast groups. Otherwise all the streams of a video content will be delivered to the serving base station even if a mobile node is not able to receive the contents associated with a given video stream.

In particular, the present invention uses a distributed radio-link-layer-aware proxy multicast group manager in the radio access network. Basically, the radio link scheduler would act as a proxy for various mobile nodes and send multicast group management messages on their behalf depending upon available radio link feedback. Although described herein in a High Speed Downlink Packet Access (HSDPA) embodiment, it should be noted that the present invention is also applicable to other communication technologies including, but not limited to, Long Term Evolution (LTE) and WiMAX.

In this mechanism, during multicast session setup, a mobile node would attempt to join all the relevant multicast groups. Some options in this setup could include: a) configure the base station with the associated priorities, b) determine priorities to additional signaling with the mobile, and c) examine the content of the different streams. Subsequent group management would be performed by the multicast proxy agent located at the base station. The proxy agent would then perform multicast group management using radio link feedback received from a scheduler. It is possible to implement the scheduler as a separate entity or as part of proxy agent. Preferably, the scheduler is implemented in a Radio Network Controller (RNC) or a base station.

The proxy agent would learn about various multicast groups being used by a mobile node by detecting (snooping) initial IGMP/Multicast Listener Discovery (IGMP/MLD) join messages. Also, the proxy agent will receive feedback from scheduler indicating the change of radio link condition associated with a given mobile. Depending upon the received indication, proxy agent will either add or drop membership to a few groups. For example, when the feedback for a given mobile indicates radio link conditions have improved (e.g. the mobile has access to more bandwidth), the proxy will add the mobile to appropriate multicast groups providing “enhanced” content by sending “join” messages on behalf of the mobile to the first hop multicast router. Conversely, when the feedback indicates the radio link conditions have worsened, the proxy will remove the mobile from appropriate multicast groups providing “enhanced” content by sending “leave” messages on behalf of the mobile to the first hop multicast router. The proxy agent would also send a report associated with the active multicast groups to a multicast address of a first hop router that is capable of supporting multicast routing.

In operation, with a broadcast-multicast channel there is an agreed upon rate that the mobiles will be receiving data in the forward direction. The Data Rate Control (DRC) and the Acknowledge (ACK) channels are not required. Specifically, one, a subset, or multiple sub-channels can be dedicated to the Time Division Multiplexed transmission of a single broadcast signal to a particular broadcast address. In order to reach the most distant mobile the appropriate modulation and coding scheme will be used. In IEEE 802.16x, a BTS can transmit to multiple users per frame (e.g., 5 ms). The portion of frame used in the downlink will depend on the amount of data sent and the modulation coding scheme of a particular mobile node. In addition, higher rates would require proportionally more resources.

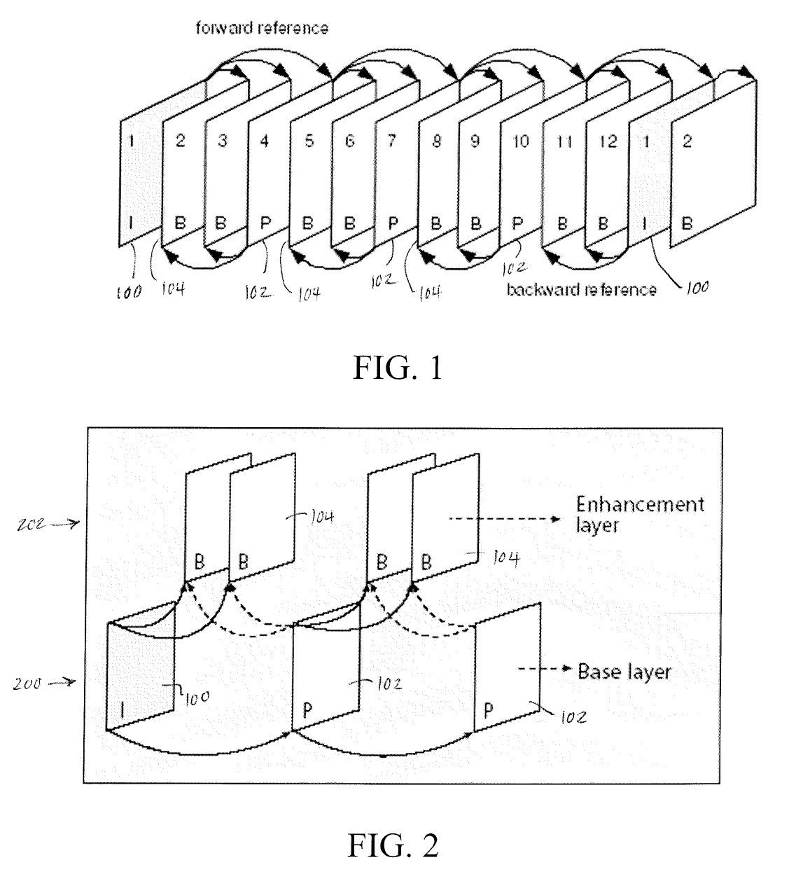

FIG. 1 illustrates a hierarchical video coding scheme used as an example of the present invention described herein. Although this example focuses on video, similar hierarchical coding can be applied for audio, text, data, etc. Video traffic typically consists of several types of frames which differ in terms of importance (e.g., for MPEG-4 the most important is the I-frames 100, then the P-frames 102, and then B-frames 104). In order to transport efficiently video frames over the air and give users in better reception spots better quality it is beneficial to transport different video frames with different modulation and coding types.

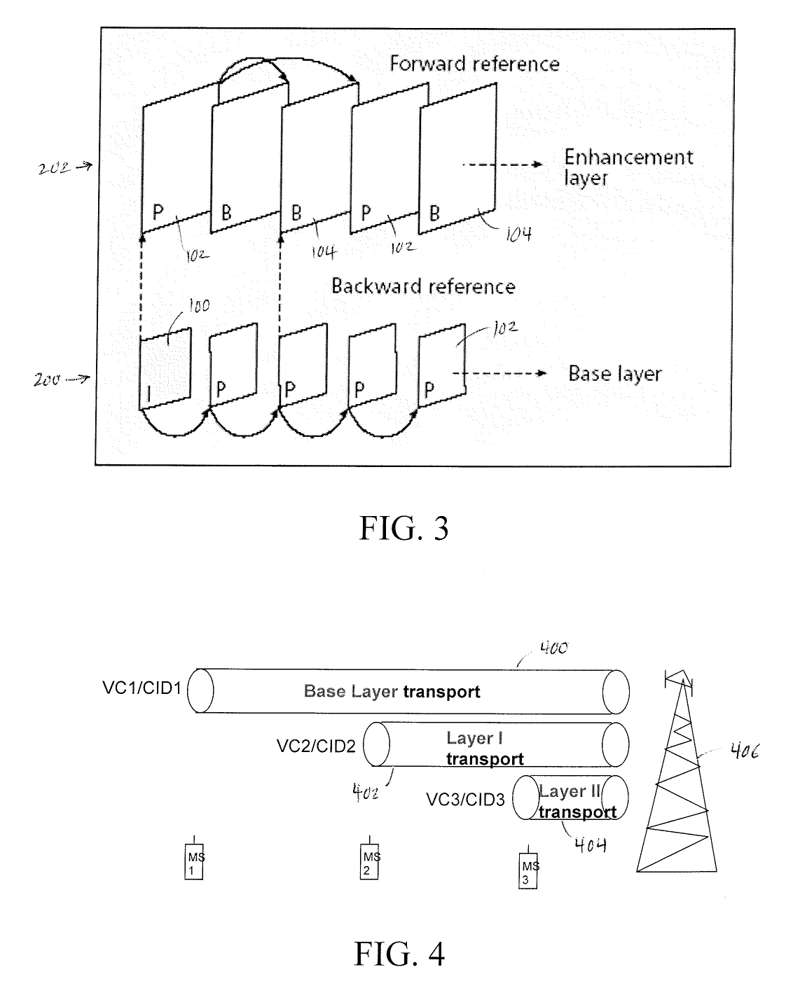

Referring to FIGS. 2 and 3, scalable video encoding has been standardized as part of the MPEG standard and provides a way to view a video stream as multiple embedded streams each stream adding to the quality of the lower (base) layer stream. With conventional layered encoding the video is encoded hierarchically into a base layer 200 and one or more enhancement layers 202. Decoding the base layer provides a basic video quality, while decoding the base layer together with the enhancement layers provides an enhanced video quality. MPEG has standardized the following scalability modes: data partitioning, temporal, spatial, and signal-to-noise (SNR). Temporal (FIG. 2) and spatial (FIG. 3) scalable encoding is shown.

Referring to FIG. 4, to provide basic video quality, the highest importance (e.g., I-frames or Base Layer frames 400) are transported with the most coding protection or at the lowest data rate to the mobile nodes able to receive it (MS 1-3). The next level is the P-frames or Enhancement Layer 1402 that need less protection and that maybe received by a user (MS 2-3) with at least medium RF quality reception. Finally, P-frames or Enhancement Layer II 404 can be sent with least protection and at a higher data rate so only the users (MS 3) with very good RF coverage will receive it. Based on the periodic feedback from the mobiles (e.g., gated DRC) or other means, the base transceiver station 406 (BTS) decides how to get the appropriate layered stream and partition the incoming video stream most efficiently.

As shown in FIG. 4, to achieve multi-rate multi-QoS transmission, multiple-rate (virtual) channels (VC) 400, 402, 404 can be used. In particular, in IEEE 802.16, different connection identifiers (CID 1-3) for different layers can be used. Similarly in LTE a different logical channel ID may be used for different stream.

Application packets carrying different video frames will be labeled differently so the BTS can classify them accordingly and send them to the appropriate VC (CID) at different rates. All users will be attempting to decode all transmissions. However, it is most likely that the users in bad RF coverage conditions will not be able to decode the enhancement layers. If feedback is received that there are no mobile nodes able to receive an enhanced layer, then there is no need to send such layer by the BTS and other traffic (VoIP, date, text, etc.) can be sent in the freed-up slots. As a result, the present invention can use a lesser number of time slots for the same rate video stream, or alternatively, use the same number of slots as previously (assuming constant over the air transmission) but sent at a higher rate video stream.

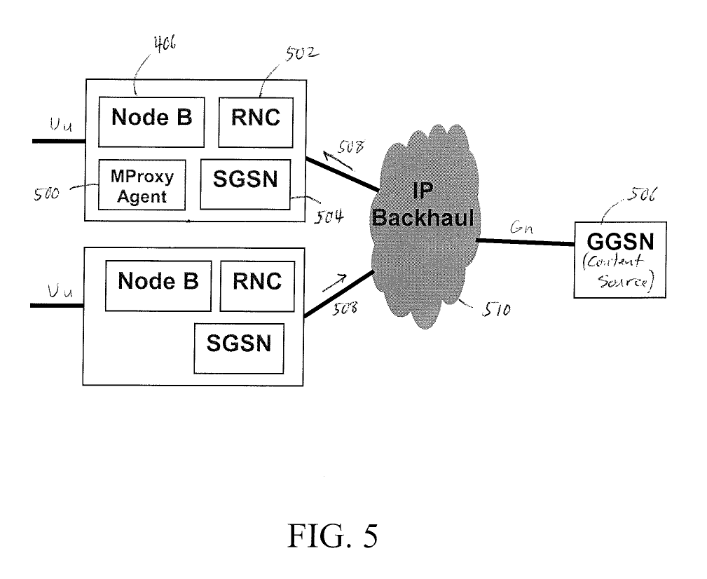

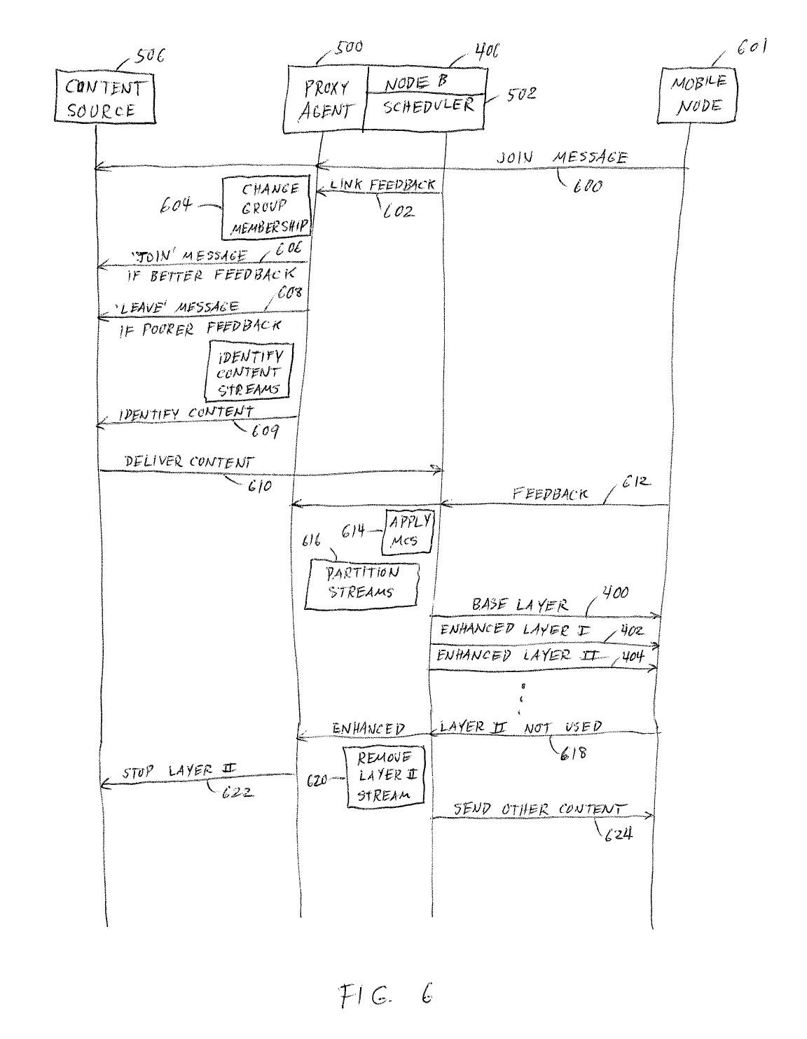

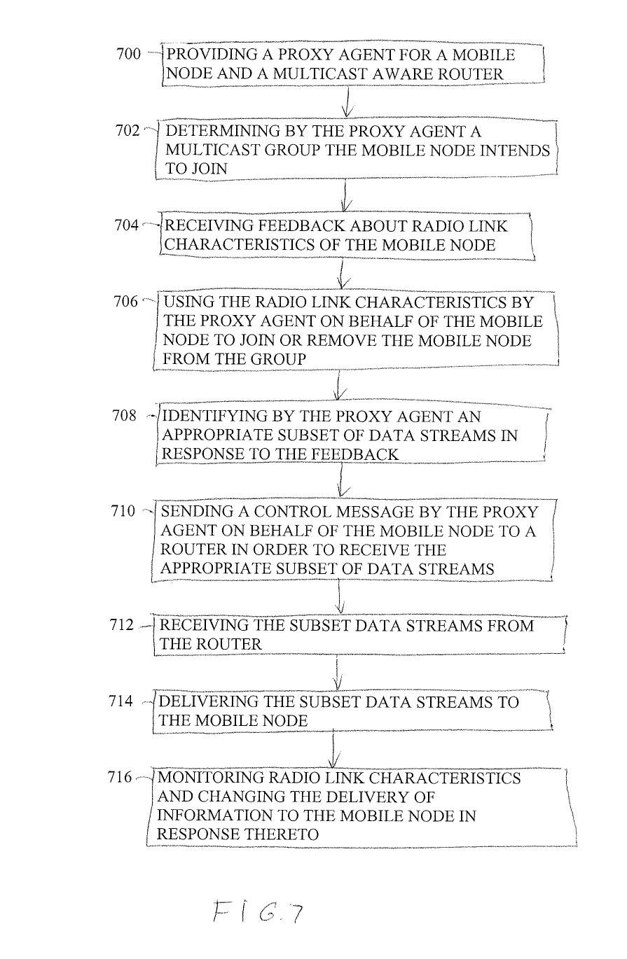

Referring to FIGS. 5 and 6, the present invention provides distributed radio-link-layer-aware proxy multicast group management architecture in a radio access network. The architecture includes a content source 506 which can be a multicast router, or other multicast service entity. The content source is communicatively coupled through one or more radio access and/or Internet Protocol (IP) networks, through a first hop multicast aware router such as a GGSN for example, to a plurality of mobile or fixed nodes that are affiliated in separate multicast groups having different communication capabilities.

A call session is initially established, as is known in the art and not shown, on communication paths for enabling a multicast communication in the communications network between the multicast content source 506 and at least one mobile node. Each mobile node typically comprises a logical entity, e.g., a user, and a physical counterpart, e.g., a terminal, as part of a group entity that is named and addressable. The preferred transactional broadcast protocol is Session Announcement Protocol (SAP). However, it should be recognized that obvious variations of the present invention could be utilized in protocols such as Session Initiation Protocol (SIP) and Session Description Protocol (SDP), for example.

To setup a session, the content source establishes the multicast call and its required applications, and sets up a multicast invitation by sending a Session Initiation Protocol (SIP) INVITE message (not shown) or Session Announcement Protocol (SAP) announcement containing Session Description Protocol (SDP) to the mobile nodes for the call. Call control signaling identifies the mobile nodes in the affiliated group. For example, the affiliated mobile nodes of the call can be paged with the identification of the group call in the SIP INVITE or SAP announcement. Alternatively, instead of a single group ID, the group invite might contain a list of all mobile nodes desired for this call. The group SIP INVITE or SAP announcement contains information that a call is being setup for the invited mobile nodes and should be acknowledged, wherein the mobile nodes are required to go through a negotiation process before participating in the multicast call. A mobile node receiving and processing the group SIP INVITE or SAP announcement can subsequently join the multicast call where the different application streams or flows can be accessed by the mobile nodes in the group.

As introduced by the present invention, a proxy agent 500 serves the various mobile nodes and sends multicast group management messages to a serving gateway 506 on their behalf depending upon available radio link feedback. In operation, during multicast session setup, a mobile node will join all the relevant groups as previously described above. Subsequent multicast group management will be performed by the multicast proxy agent 500 located at the base station 406 using radio link feedback received from a radio link scheduler (RNC or base station 502). The proxy agent will learn about various multicast groups being used by a mobile node 601 by detecting (snooping) initial IGMP/MLD Join Messages 600.

The proxy agent 500 will receive feedback 602 from the scheduler 502 indicating a change of radio link condition associated with a given mobile node, e.g. 601. Depending upon the received indication, the proxy agent 500 can change 604 the group membership of the mobile node by either adding or dropping the mobile node's membership to a few groups by sending IGMP JOIN or LEAVE messages 606, 608 on behalf of the mobile node 601 to a first hop multicast router 506. The proxy agent 500 will also send a report associated with active multicast groups to a multicast address of a first hop router that is capable of supporting multicast routing to process this report.

A novel aspect of the present invention is the concept of a distributed IGMP proxy. Basically, the BTS will have a proxy for each mobile node and act on behalf of the mobile node based upon received feedback from the scheduler. The proxy agent will send an IGMP ‘leave’ message on behalf of a mobile node when the mobile node radio link condition dictates that the mobile node won't be able to receive a data flow belonging to a given multimedia stream. Similarly, the proxy agent will send an IGMP ‘join’ message as soon as it detects that the mobile node radio link condition has improved and the mobile node is now able to receive the data flow belonging to a given multimedia stream.

The present invention can be implemented in any wireless access network. In a specific example, to implement the present invention in an HSDPA access network, a BTS will need to be modified to support a multicast proxy agent function, and a GGSN will need to be enhanced to provide a multicast routing function. The proxy agent function will provide several high-level functions.

Firstly, the proxy agent will decide when a mobile intends to join a multicast group. This can be done by snooping initial IGMP messages sent by the mobile node. Snooping is only required if there is no other method available to identify this. During inter-NodeB mobility, this information 508 will be forwarded from an old BTS to a new BTS using context transfer protocol.

Secondly, the proxy agent will proactively manage multicast group membership on behalf of the mobile node to ensure optimal use of network and backhaul resources. To ensure optimal network and backhaul 510 usage, the proxy agent 500 will monitor the radio link feedback from a scheduler 502 associated with a given mobile node and perform the following functions: a) using available radio link bandwidth, QoS, etc., the proxy agent will identify 604 an appropriate subset of video streams associated with a given content to be delivered to mobile node, b) the proxy agent will send IGMP control messages 606, 608, 609 on behalf of the mobile node so that the Node B 406 is able to receive appropriate multicast streams 610 associated with a given content, and c) the proxy agent will send IGMP control messages 606, 608, 609 by injecting the control messages to the appropriate GTP tunnel associated with the mobile node. The IGMP control messages will by decoded by a multicast aware GGSN 506 or other routers to ensure that only appropriate multicast flows are routed 610 towards the radio link thereby minimizing the usage of network and backhaul resources.

Upon receipt of the stream 610, and based on the periodic feedback 612 from the mobiles (e.g., gated DRC) or other means, the Node B 406 establishes what specific application streams (flows) are available or required for each mobile node of the group call, decides what modulation coding scheme to apply 614, and how to partition 616 the incoming video stream most efficiently. In this example, the Node B partitions a video data stream 610 into a base layer 400 and two enhancement layers 402, 404. An IEEE 802.16e network would use different CID's for different layers. However, it should be recognized that the applications or flows can also include audio (voice), text messaging, and internet protocols, for example, each of which require different resources or capabilities in a mobile node that participates in the group call, and that different mobile nodes of the group could have a wide range of resources or capabilities, and some may not be able to participate in the full group session due to such limitations.

Subsequently, if feedback 618 is received that there are no mobile nodes 601 able to receive an enhanced layer (e.g. enhanced layer II), then there is no need to send such layer by the Node B, whereupon the Node B stops sending that stream 620 and notifies 622 the multicast router 506 that it need not send that stream of content. In addition, the Node B 406 can send 624 other traffic (VoIP, date, text, etc.) in place of the unused data stream in the freed-up slots.

Optionally, in the above examples the decision to start or stop sending a particular stream could be additionally gated by the activity of other flows. For example, in the case of low traffic load the stream could continue to be sent which would cause the mobile to pick up the stream quicker when the RF conditions improve.

It should be recognized that the diagrams herein are simplified for purposes of illustrating the present invention. However, those of ordinary skill in the art will realize that many other network entities may be part of the communication system. For example, the proxy agent can be included in many other entities which have not been shown for the sake of simplicity. For example, the proxy agent can be incorporated in one or more of a session controller, a group database manager, a registration manager, an application layer router, a group entity manager, a broadcast and unicast address manager, a policy manager, a flow controller, a media manager, and a bandwidth manager, among others, all of which are known in the art. It should be appreciated that the above described entities can be integrated in the same physical or logical network element or provided as distributed or individual physical or logical network elements.

FIG. 7 illustrates a method for multiple multimedia data stream delivery in a communication network.

The method includes a first step 700 of providing a proxy agent for a mobile node and a multicast aware router. Preferably, the router is an enhanced multicast aware GGSN, and the proxy agent is provided as part of a serving Node B.

A next step 702 includes determining by the proxy agent a multicast group the mobile node intends to join. Preferably, this is accomplished by detecting an initial IGMP message sent by the mobile node. Optionally, during handover, this information can be forwarded from a serving Node B to a target Node B during mobile node mobility from the serving Node B to the target Node B.

A next step 704 includes receiving feedback about radio link characteristics of the mobile node by the proxy agent. The feedback will determine in what capability the mobile unit will join the group, or whether it will leave the group.

A next step 706 includes using the radio link characteristics by the proxy agent on behalf of the mobile node to join or remove the mobile node from the group.

A next step 708 includes identifying by the proxy agent an appropriate subset of data streams associated with content for the group in response to the feedback.

A next step 710 includes sending a control message by the proxy agent on behalf of the mobile node to a router in order to receive the appropriate subset of data streams. Preferably, this is accomplished by injecting an IGMP control message into a GTP tunnel associated with the mobile node. At this point, the multicast aware router can decode the control message and route only the appropriate multicast data stream for the mobile node in response to the control message. In this way, the Node B need not carry any information that could not be delivered to the mobile node.

A next step 712 includes receiving the subset data streams from the router.

A next step 714 includes delivering the subset data streams to the mobile node.

A next step 716 includes dynamically monitoring the radio link characteristics of the mobile node by the proxy agent and changing the delivery of information to the mobile node in response thereto. The monitoring will determine whether the mobile unit now has capability for additional information causing the proxy agent to increase the quality of information to the mobile node, or whether radio conditions have deteriorated causing the proxy agent to reduce the quality or eliminate the information to the mobile node (e.g. remove it from the group).

Advantageously, the present invention optimizes the resource use by multicast routers and the access network backhaul. It further optimizes radio link usage by eliminating multicast management messages from the radio link. The present invention can be implemented by next generation 802.16x, LTE, UMB, UMTS, and DO-A based radio access networks without making any changes to Radio (e.g., 3GPP) or IETF standards, provided that the Node B is able to snoop IP packets sent by the mobile node (i.e. radio links and/or GTP tunnel messages) and inject IP messages (i.e. IGMP control messages) on behalf of mobile node.

The present invention is efficient for use with both the backhaul and the air-interface. Sometimes the backhaul will not be a problem and air-interface will be the only bottleneck. In this case, the proxy can perform a filtering function and forward specific flows to the scheduler.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for multiple multimedia data stream delivery in a communication network, the method comprising the steps of:
providing a proxy agent for a mobile node;
determining a multicast group the mobile node intends to join;
receiving feedback about radio link characteristics of the mobile node by the proxy agent; and
using the radio link characteristics by the proxy agent on behalf of the mobile node to join or remove the mobile node from the group.

2. The method of claim 1, wherein the determining step comprises detecting an initial IGMP message sent by the mobile node.

3. The method of claim 1, wherein the determining step includes forwarding information about the determining step from a serving Node B to a target Node B during mobile node mobility from the serving Node B to the target Node B.

4. The method of claim 1, further comprising the steps of:
identifying an appropriate subset of data streams associated with content for the group in response to the feedback;
sending a control message on behalf of the mobile node to a router in order to receive the appropriate subset of data streams;
receiving the subset data streams; and
delivering the subset data streams to the mobile node.

5. The method of claim 4, wherein the sending step includes injecting the control message into a GTP tunnel associated with the mobile node.

6. The method of claim 5, wherein the control message is an IGMP control message.

7. The method of claim 4, wherein the sending step includes decoding the control message by a multicast-aware router, and the receiving step includes routing only the appropriate multicast data stream in response to the control message.

8. The method of claim 1, wherein the providing step includes providing an enhanced GGSN as a multicast aware router.

9. A method for multiple multimedia data stream delivery in a communication network, the method comprising the steps of:
providing a proxy agent for a mobile node and a multicast aware router;
determining by the proxy agent a multicast group the mobile node intends to join;
receiving feedback about radio link characteristics of the mobile node by the proxy agent;
using the radio link characteristics by the proxy agent on behalf of the mobile node to join or remove the mobile node from the group;
identifying by the proxy agent an appropriate subset of data streams associated with content for the group in response to the feedback;
sending a control message by the proxy agent on behalf of the mobile node to a router in order to receive the appropriate subset of data streams;
receiving the subset data streams from the router; and
delivering the subset data streams to the mobile node.

10. The method of claim 9, wherein the determining step comprises detecting an initial IGMP message sent by the mobile node.

11. The method of claim 9, wherein the determining step includes forwarding information about the determining step from a serving Node B to a target Node B during mobile node mobility from the serving Node B to the target Node B.

12. The method of claim 9, wherein the sending step includes injecting the control message into a GTP tunnel associated with the mobile node.

13. The method of claim 12, wherein the control message is an IGMP control message.

14. The method of claim 9, wherein the sending step includes decoding the control message by the multicast aware router, and the receiving step includes routing only the appropriate multicast data stream in response to the control message.

15. The method of claim 9, wherein in the providing step an enhanced GGSN is used as the multicast aware router.

16. The method of claim 9, further comprising the step of monitoring the radio link characteristics by the proxy agent and changing the delivery of information to the mobile node in response thereto.

17. A network for multiple multimedia data stream delivery comprising:
a proxy agent for a mobile node, the proxy agent coupled to a scheduler for the mobile node, the proxy agent determines a multicast group the mobile node intends to join, and receives feedback about radio link characteristics of the mobile node, the proxy agent uses the radio link characteristics on behalf of the mobile node to join or remove the mobile node from the group.

18. The network of claim 17, wherein the proxy agent also identifies an appropriate subset of data streams associated with content for the group in response to the feedback, and sends a control message on behalf of the mobile node in order to receive the appropriate subset of data streams, and further comprising:
a multicast aware router that receives the control message from the proxy agent, and sends the subset of data streams for delivery to the mobile node.

19. The network of claim 18, wherein the router also decodes the control message, and routes only the appropriate multicast data stream in response to the control message.

20. The network of claim 18 wherein the proxy agent also monitors the radio link characteristics of the mobile node and changes the delivery of information to the mobile node in response thereto.
